(19) United States
(12) Patent Application Publication
(10) Pub. No.: US 2003/0117605 A1
(43) Pub. Date: Jun. 26, 2003

(54) Apparatus and method for contact hole exposure

(75) Inventor: Yuan-Hsun Wu, Chungki City (TW)

Correspondence Address: Richard P. Berg, Esq., c/o LADAS & PARRY, Suite 2100, 5670 Wilshire Boulevard, Los Angeles, CA, 90036-5679, US

(73) Assignee: NANYA TECHNOLOGY CORPORATION

(21) Appl. No.: 10/177,476

(22) Filed: Jun. 20, 2002

(30) Foreign Application Priority Data
Dec. 20, 2001 (TW) 90131750

(51) Int. Cl. G03B 27/54

(52) U.S. Cl. 355/67

(57) ABSTRACT

Apparatus and method for contact hole exposure. First, an exposure apparatus including a light source and a lens comprising a central transparent area and at least one dummy transparent area is provided. Next, a mask having a plurality of contact hole patterns is provided. Finally, exposure is performed to transmit light from the light source through the mask. Additionally, the exposure apparatus comprises a light source producing light and a lens having a central transparent area and at least one dummy transparent area transmitting the light for exposure.

### BACKGROUND OF THE INVENTION

1. Field of the Invention

The present invention relates in general to semiconductor manufacturing, and particularly to photolithography.

2. Description of the Related Art

In the manufacture of semiconductor wafers, photolithography is used to pattern various layers on a wafer. A layer of resist is deposited on the wafer and exposed using an exposure tool and a template such as a mask. During the exposure process a form of radiant energy such as ultraviolet light is directed through the mask to selectively expose the resist in a desired pattern. The resist is then developed to remove either the exposed portions for a positive resist or the unexposed portions for a negative resist, thereby forming a resist mask on the wafer. The resist mask can then be used to protect underlying areas of the wafer during subsequent fabrication processes, such as deposition, etching, or ion implantation processes.

An integral component of photolithography is the mask. The mask includes the pattern corresponding to features (e.g., transistors or polygates) at a layer of the integrated circuit (IC) design. The mask is typically a transparent glass plate coated with a patterned light blocking material such as, for example, MoSiₓO_{y}. This type of mask is typically referred to as a binary mask since light is part blocked by the light blocking material and fully transmitted through the transparent glass portions.

There are problems with the PSM mask. Light passing through the edge of contact hole patterns within the mask (e.g., the boundary between a light blocking region and a transparent region) is often diffracted. This means that instead of producing a very sharp image of the contact holes on the resist layer, some lower intensity light diffracts beyond the intended contact hole boundary and into the regions expected to remain dark. Hence, the resultant feature shapes and sizes deviate somewhat from the intended IC design. Since integrated circuit manufacturers have continued to reduce the geometric size of the IC features, this diffraction produces wafers with incomplete or erroneous circuit patterns.

FIG. 1 illustrates a portion of a mask 10 for contact hole patterns. The mask 10 comprises a transparent portion 20 that permits transmission of radiant energy, such as ultraviolet light.

FIG. 2 illustrates the printable patterns on a photoresist 30 after an exposure and a development using the mask 10. There are not only a plurality of circular contact holes 40 but also side lobes 50 produced by diffraction among the contact holes 40.

As known in the art, the side lobe effect becomes more pronounced as the spacing between the IC features decreases, especially for contact hole formation. That is, when contact holes are designed close to each other, as in the current trend, the electric field and intensity components associated with the side lobes of each feature begin to overlap and add up. This causes side lobes of greater amplitude and increases the side lobe effect. Sometimes, the amplitude of these “additive” side lobes is greater than the amplitude of the desired features, which further corrupts the fabrication process.

One way to solve the side lobe problem in photolithography is the application of a phase-shifting mask (PSM). Dummy patterns are designed in a PSM to reduce side lobe by diffraction. However, it is difficult to fabricate the PSM.

Increasing the degree of coherence of the lens is another way to solve the above mentioned side lobe problem. However, the depth of focus (DOF) decreases with the increase. Thus, the process window of photolithography is narrow.

### SUMMARY OF THE INVENTION

The object of the present invention is to provide an apparatus and method for contact hole exposure to avoid side lobe problem.

The method comprises the following steps. First, an exposure apparatus including a light source and a lens is provided, wherein the lens comprises a central transparent area and at least one dummy transparent area. Next, a mask having a plurality of contact hole patterns is provided. Finally, exposure is performed to transmit a light from the light source through the mask.

According to the concept of the present invention, the light for exposure can be deep ultraviolet (UV) ray. The contact hole patterns are set in array, and the contact hole is circular.

An exposure apparatus comprises a lens and a light source to produce a light for exposure, wherein the lens has a central transparent area and at least one dummy transparent area to transmit the light for exposure.

According to the concept of the present invention, the central transparent area is circular. The dummy transparent area is rectangular and is located in the corners of the lens. The number of dummy transparent areas is four.

### BRIEF DESCRIPTION OF THE DRAWINGS

The above and other objects, features, and advantages of the present invention will become apparent from the following detailed description of preferred embodiments of the invention explained with reference to the accompanying drawings, in which:

FIG. 1 is a top view schematic drawing showing a mask having contact hole patterns.

FIG. 2 is schematic drawing illustrating the side lobe problem according to the prior art.

FIG. 3 is a schematic cross-section of the apparatus according to the preferred embodiment of the invention.

FIG. 4 is a top view schematic drawing of the lens according to the preferred embodiment of the invention.

FIG. 5 is a schematic drawing showing photoresist patterns after an exposure and a development by the mask of FIG. 1 according to the preferred embodiment of the invention.

### DETAILED DESCRIPTION OF THE INVENTION

There will now be described an embodiment of this invention with reference to the accompanying drawings.

First, an exposure apparatus 100 including a light source 400 and a lens 300 is provided, wherein the lens 30 comprises a central transparent area and at least one dummy transparent area. Finally, exposure is performed to transmit a light 900 from the light source 400 through the mask 10 into a photoresist 500. The light 900 comprises deep ultraviolet (UV) light.

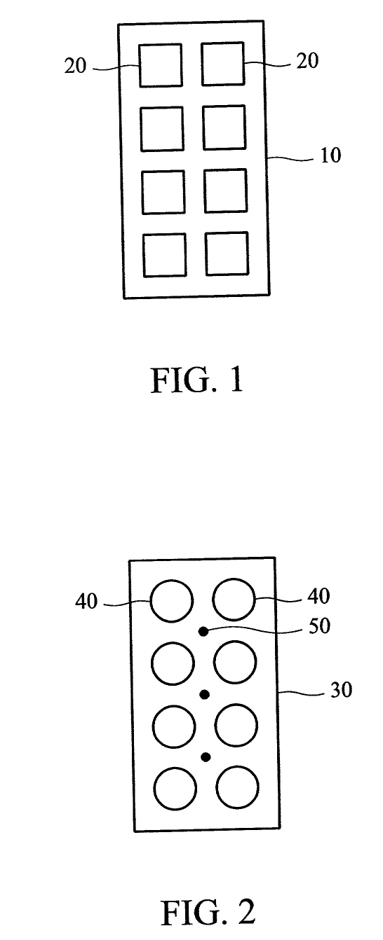

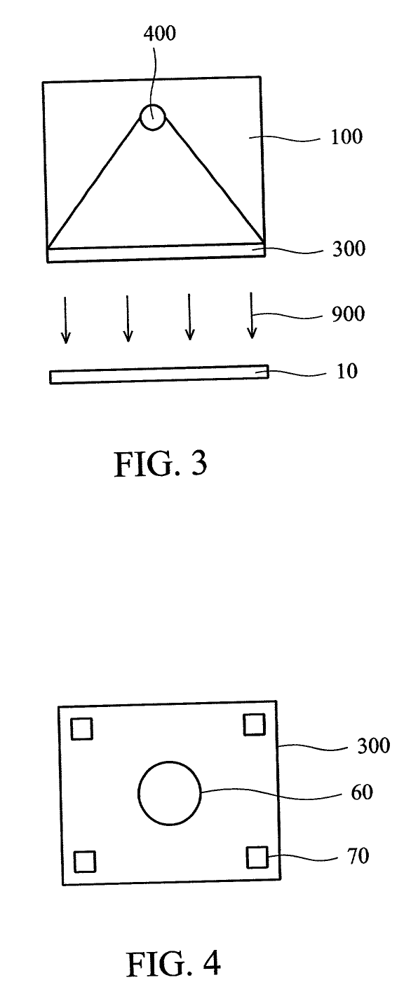

A mask 10 having a plurality of rectangular contact hole patterns 20 set in array is provided, as shown in FIG. 1. The lens 300, as shown in FIG. 4, has a central transparent area 60 and at least one dummy transparent area 300 to transmit the light for exposure. The central transparent area 60 can be circular, and the dummy transparent area 70 can be rectangular. There can be four dummy transparent areas 70 located in the corners of the lens 300.

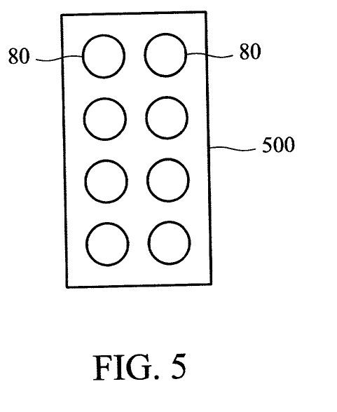

As shown in FIG. 5, a plurality of contact holes 80 is formed on the photoresist 500 after the above exposure and a development. Under this method no side lobes occur.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. An exposure method for contact holes, comprising:
providing an exposure apparatus including a light source and a lens, wherein the lens comprises a central transparent area and at least one dummy transparent area;
providing a mask having a plurality of contact hole patterns; and
performing exposure with a light from the light source transmitting through the lens and the mask.

2. The method as claimed in claim 1, wherein the light is deep ultraviolet (UV).

3. The method as claimed in claim 1, wherein the central transparent area is circular.

4. The method as claimed in claim 1, wherein the dummy transparent area is rectangular.

5. The method as claimed in claim 1, wherein the dummy transparent area is located in the corners of the lens.

6. The method as claimed in claim 5, wherein the number of dummy transparent areas is four.

7. The method as claimed in claim 1, wherein the contact hole patterns on the mask are circular.

8. The method as claimed in claim 1 wherein the contact hole patterns are set in array.

9. An exposure apparatus, comprising:
a light source, producing a light; and
a lens, having a central transparent area and at least one dummy transparent area, transmitting the light for exposure.

10. The apparatus as claimed in claim 9, wherein the light is deep ultraviolet (UV).

11. The apparatus as claimed in claim 9, wherein the central transparent area is circular.

12. The apparatus as claimed in claim 9, wherein the dummy transparent area is rectangular.

13. The apparatus as claimed in claim 9, wherein the dummy transparent areas are located in the corners of the lens.

14. The apparatus as claimed in claim 9, wherein the number of dummy transparent areas is four.
